(19) United States
(12) Patent Application Publication
(10) Pub. No.: US 2024/0010447 A1
(43) Pub. Date: Jan. 11, 2024

(54) CONVEYOR DEVICE

(71) Applicant: INTERROLL HOLDING AG, Sant 'Antonio (CH)

(72) Inventors: Stefan Hamacher, Hückelhoven (DE); Stephan Kronholz, Hückelhoven (DE); Kai Lubomierski, Hückelhoven (DE); Jan Oberländer, Düsseldorf (DE); Thomas Rydlewski, Düsseldorf (DE); Jürgen Zinn, Düsseldorf (DE); Klaus Baltes, Bergheim (DE); Erwin Mans, Hückelhoven (DE); Muammer Genc, Mönchengladbach (DE)

(21) Appl. No.: 18/267,094

(22) PCT Filed: Dec. 10, 2021
(86) PCT No.: PCT/EP2021/085275

§ 371 Date: Jun. 13, 2023

(30) Foreign Application Priority Data
Dec. 18, 2020 (DE) 10 2020 134 233.0
Mar. 24, 2021 (DE) 10 2021 107 401.0
Apr. 16, 2021 (DE) 10 2021 109 659.6
Aug. 31, 2021 (DE) 10 2021 122 513.2

(51) Int. Cl. B65G 47/96; B65G 47/57; B65G 45/12; B65G 17/00; B65G 17/36

(52) U.S. Cl. CPC B65G 47/965; B65G 47/57; B65G 45/12; B65G 17/005; B65G 17/36; B65G 2201/0202

(57) ABSTRACT

The invention relates to a conveyor device (1), designed: to receive an item to be conveyed (F2), more particularly a meat item, at a receiving region (A1) from an upstream feed device (110); to transfer the item to be conveyed (F2) at a transfer region (A3); to hand over the item to be conveyed (F2) in a handover region (A2) from the receiving region (A1) to the transfer region (A3), wherein the conveyor device (1) comprises a plurality of discrete transport units (21), wherein the transport units (21) are more particularly arranged in circulation, characterized in that the transport units (21) are designed: to receive the item to be conveyed (F2) at the receiving region (A1), to be handed over between the receiving region (A1) and the transfer region (A3), and to hand over the item to be conveyed (F2) at the transfer region (A3).

### BACKGROUND OF THE INVENTION

The invention relates to a conveyor device.

Hygiene plays a very important role in particular in the food industry. It is unavoidable that food comes into contact with microbiological germs. However, the extent of the contamination has a significant effect on the shelf life of the food.

Therefore, the equipment involved in food processing is constantly cleaned. Cleaning must take place at defined intervals, which are determined depending on the respective contamination or contamination with biological germs. In other words, in the case of an increased contamination load, cleaning is carried out more frequently than in the case of a lower contamination load. For a deep cleaning of the plants, parts of the production have to be shut down.

In particular in the meat processing industry, meat is often cut in order to separate individual pieces of meat from a carcass. In highly optimized processes, cutting operations take place very quickly, so that the proverbial “sparks fly”. These sparks now fly uncontrolled through the air and, in addition to the good parts, increase contamination on contact surfaces for processing and transporting the food parts. This increased contamination, in turn, leads to increased cleaning needs and efforts. In the context of the present description, meat is expressly understood to include fish meat as well as poultry meat.

In particular, the collection of meat parts after a meat cutting device has so far been carried out by means of stainless steel plates along which the meat parts slide. Each piece of meat sliding along contaminates the stainless steel sheet along the slide; the contaminated stainless steel sheet in turn contaminates each subsequent piece of meat with the microbiological germs of the previous pieces of meat. Thus, the contaminations multiply. Such an arrangement is disclosed in WO 2020/164759 A1.

US 2010/0 221 991 A1 discloses a device whose primary task is the skinning of poultry parts. The poultry parts are guided individually in containers over a skinning tool.

Consequently, conveying solutions are now required that can be used in the food processing environment and take the above-mentioned boundary conditions into account.

### BRIEF SUMMARY OF THE INVENTION

It is the object of the present invention to provide a suitable conveyor device for the food sector, which can be fitted in particular downstream of a meat cutting device, since contamination by small pieces of meat flying around is particularly high here.

The object underlying the invention is solved by a conveyor device, a conveying arrangement and a use according to the main claims. Embodiments are subject of the subclaims and the description.

The conveyor device is characterized by a plurality of discrete transport units that can receive the product parts for conveying. The transport units isolated can be comparatively small and therefore provide only a small collection surface for contaminating, undesirable cutting by-products. Undesirable slipping along surfaces is prevented. In particular, the use of walls with recesses reduces the contact surfaces.

In particular, when the product parts are provided at the takeover area, they are in a vertically falling state.

The multiplication of the contaminations described at the beginning can at least be reduced by the invention. Any reduction of the multiplication in turn allows an extension of the shelf life and/or an increase of the cleaning intervals.

The infeed conveyor can be, in particular, an overhead conveyor.

The transport units are particularly designed to receive product parts with a mass of at least 100 gr, 30 200 gr, 300 gr, 400 gr, 500 gr, 600 gr, 700 gr, 800 gr, 900 gr or 1000 gr and a maximum of 200 gr, 300 gr, 400 gr, 500 gr, 600 gr, 700 gr, 800 gr, 900 gr, 1000 gr, 1200 gr, 1400 gr or 1600 gr of food. The transport units define a receiving space suitable for containing disassembled food products having a volume of at least 1000 cm², 1500 cm², 2000 cm², 2500 cm³, 3000 cm³, 3500 cm³, 4000 cm³, 4500 cm³ or 5000 cm³ and/or a maximum of 1000 cm³, 1500 cm³, 2000 cm³, 2500 cm², 3000 cm³, 3500 cm³, 4000 cm³, 4500 cm³ or 5000 cm³. In particular, the transport units have a width and/or length and/or height of at least 5 cm, 10 cm, 5, 15 cm, 20 cm, 25 cm, 30 cm, 40 cm or 50 cm and/or a maximum width and/or length and/or height of at least 10 cm, 15 cm, 20 cm, 25 cm, 30 cm, 40 cm or 50 cm.

In particular, the conveyor device according to the invention is set up for collecting meat parts that are discharged from a cutting device, in particular a meat cutting machine.

The support rail, the base support, the rail holder and/or other components of the device have, in particular, a stainless steel surface.

### BRIEF DESCRIPTION OF THE DRAWINGS

The invention is explained in more detail below with reference to the figures; herein show:

FIG. 1 a schematically the structure of a conveyor arrangement according to the invention with a conveyor device according to the invention;

FIG. 2 schematically a function of the conveyor device in the context of the conveyor arrangement;

FIG. 3 a transport unit in different views;

FIG. 4 a transport carriage in different views;

FIG. 5 the arrangement of transport carriage and transport unit
a) in a receiving position,
b) in a handover position;

FIG. 6 schematically a section of a conveyor system with several handover areas;

FIG. 7 a section of the conveyor in a top view of the takeover area;

FIG. 8 a schematic comparison of the total collection surface with the individual collection surface;

FIG. 9 a section of a support arrangement of the conveyor in side view;

FIG. 10 a section of the support arrangement of the conveyor in perspective view;

FIG. 11 a section of the support arrangement of the conveyor in a further side view;

FIG. 12 a rope attachment in detail in cross-section;

FIG. 13 a section of the takeover area with two transport units as seen from direction of view XIII according to FIG. 7 in one embodiment;

FIG. 14 a section of the takeover area with two transport units as seen from direction of view XIII according to FIG. 7 in another embodiment;

FIG. 15 a section of the takeover area with two transport units as seen from direction of view XV according to FIG. 1 in one embodiment;

FIG. 16 a section of the takeover area according to FIG. 15 as seen from direction XVI according to FIG. 15;

FIG. 17 a section of the return area and the takeover area of the conveyor device of FIG. 1 in perspective view;

FIG. 18 a section of the return area and the takeover area from FIG. 17 in a different perspective.

### DETAILED DESCRIPTION

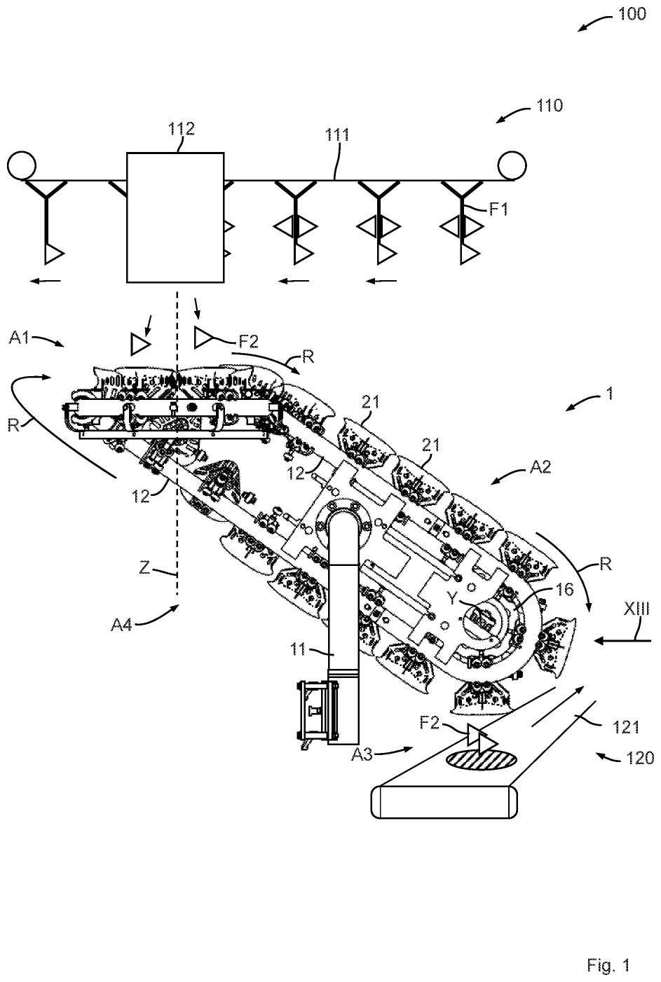

FIG. 1 shows a conveying arrangement 100 according to the invention. The conveying arrangement 100 comprises a feeding device 110, by which product parts F2 are provided. These product parts F2 are in particular poultry meat parts, such as chicken wings, chicken breasts or chicken thighs.

The feeding device 110 comprises a feeding conveyor 111, which can be designed as an overhead conveyor. Larger product units F1 are conveyed to this feed conveyor. These product units F1 are in particular a poultry carcass.

The feeding device 110 comprises a discharging unit 112, which provides product parts F2 of the product unit F1. In particular, the discharging unit comprises a dismantling device which separates the product parts F2 from the product units F1.

The product parts are finally transported away by a discharging device 120. The discharging device 120 can have a discharging conveyor 121, in particular a conveyor belt.

A conveyor device 1 according to the invention is provided for transferring the product parts F2 from the feeding device 110 to the discharging device 120. The conveyor device 1 is adapted to take over the product parts F2 from the feed conveyor 111 at a takeover area A1 and to transfer them to the discharge device 120 at a handover area A3.

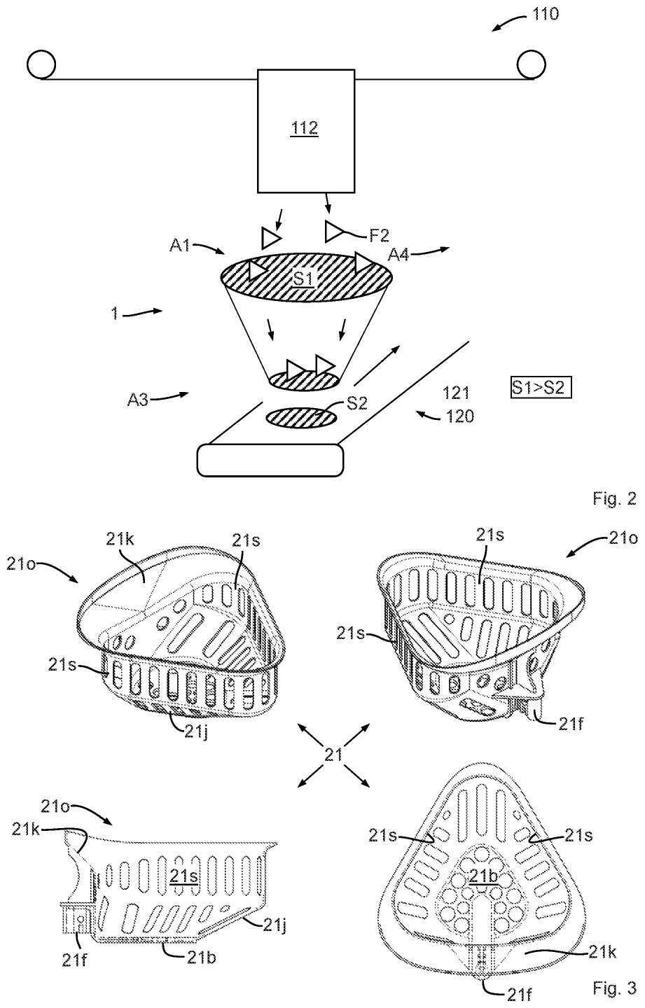

FIG. 2 shows in a reduced representation a function of the conveyor device 1 within the conveying arrangement 100. The provision of the product parts F2 at the takeover area A1 and the delivery of the product parts F2 at the handover area A3 are shown schematically. It can be seen that the takeover area A1, viewed in top view, has a first surface area S1 which is significantly larger than a second surface area S2, viewed in top view, of the handover area A3. This is due to the fact that the delivery unit 112 provides the product parts F2 in a large spatial dispersion.

Consequently, the conveyor device 1 fulfills a spatially funneling function in order to position the product parts F2 arriving at the takeover area A1 in a spatially widely scattered manner in a defined manner in a comparatively small handover area A3.

In conventional conveyor arrangements, this funneling function is performed by a suitably shaped stainless steel plate between the takeover area A1 and the handover area A3. The product parts F2 slide along the stainless steel plate. Each part leaves behind individual contaminations. After about one hour of operation, there are individual contaminations on the stainless steel sheet, for example from several thousand product units F1. Further product parts sliding along now come into contact with these contaminations.

The present invention now provides a way for the individual product parts to become significantly less contaminated with contaminants from other product parts. For this purpose, a conveyor device according to the invention is used instead of the stainless steel sheet, which is explained in more detail below.

The conveyor device 1 according to the invention (see FIG. 1) comprises a plurality of transport units 21. Such a transport unit 21 can, for example, be designed as a basket. Other forms are also possible, although it should be ensured that the transport unit 21 can safely pick up the product parts F2 and selectively deliver them again.

The transport units 21 are arranged to be transferable along a conveying direction R between the takeover area A1 and the handover area A3. At the takeover area A1, a transport unit 21 takes over one or more product parts F2 and transports them to the handover area A3, where the transported product parts F2 are handed over to the discharge device 120. Downstream of the takeover area A1 in the conveying direction R and upstream of the handover area A3 is a transfer area A2, which is essentially provided for bridging a distance between the takeover area A1 and the handover area A3. Upstream of the takeover area A1 in the conveying direction R and downstream of the handover area A3 is a return area A4, which is essentially provided for returning the transport units 21 from the handover area A3 to the takeover area A1. The conveying direction R is circulating, so that the transport units return to a starting position after one circulation.

The transport units (FIG. 3) comprise side walls 21s and a base 21b. The side walls 21s and the base 21b form a receiving space for receiving the product parts. The product parts can enter or leave the receiving space through a receiving opening 21o.

The walls have a plurality of recesses 21a. The recesses 21a are arranged on the base 21b and the side walls 21s in such a way that the product parts are held reliably in the receiving space, but on the other hand the contact area between the product parts and the transport unit is as small as possible. The transmission paths of contamination are thus reduced to a minimum. The walls (base and side walls) form a downwardly pronounced taper 21j. This reduces the outer circumference of the transport unit downwards.

Above a first fastening section 21f, the side wall 21s has a collar 21k that covers the first fastening section 21f when viewed from above. The collar 21k is inclined downward in the direction of the receiving space. Falling product parts F2 are thus kept away from the first fastening section 21f and guided into the receiving space as conveyed goods F2.

In top view, the transport unit 21 has a triangular shape in particular. This will be discussed later.

The conveyor device 1 comprises a base support 11. A support rail 12 is attached to the base support 11. The support rail 11 defines the conveying direction R. The transport units 21 are movably arranged on the support rail 12. The support rail 12 can be composed of several individual support rail segments.

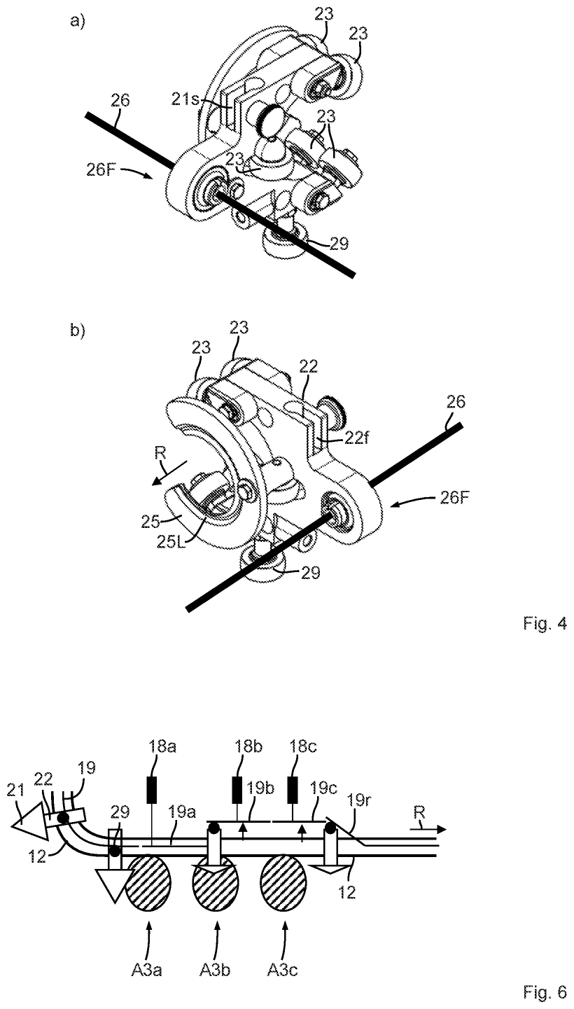

The transport units 21 are each attached as to a transport carriage 22 (FIGS. 3, 4). The transport carriage can travel along the support rail 12. Transport rollers 23 are attached to the transport carriage 22, which roll along the support rail 12. The transport rollers 23 are arranged on the transport carriage 22 in such a way that the transport carriage 22 can be moved along only one translational degree of freedom, namely the conveying direction R.

The support rail 12 has a circular cross-section. The transport rollers 23 are arranged circumferentially distributed around the circular cross-section of the support rail 12. The transport rollers 23 are arranged on the transport carriage 22 such that the transport carriage 22 is movable along a rotational degree of freedom. The rotational degree of freedom corresponds to the circumferential direction of the circular cross-section.

The transport carriage has a C-shaped configuration as viewed in the conveying direction R. This makes it possible for the transport carriage to grip around the circular rail at least in the circumferential direction by more than 180°, which is important for a stable mounting. Furthermore, the transport carriage can readily pass rail holders 13 which are connected to the support rail 12 at regular intervals and connect the support rails to the base support 11.

The transport carriage 22 has a second fastening section 22f to which the first fastening section 21f of the transport units 21 is connected. The two fastening sections are configured such that they define a defined orientation of the transport unit 21 relative to the transport carriage 22. Consequently, in conveying operation, the transport unit 21 is immovable relative to the transport carriage 22. This does not preclude the transport unit 21 can be detached from the transport carriage 22.

The transport carriage 22 is designed to pivot, which is made possible in particular by the above-mentioned rotational degree of freedom. By pivoting the transport carriage 22, the transport unit 21 is also pivoted (FIG. 5). In the pivoted state (handover position), the parts can be removed from the receiving space in a defined manner due to gravity.

The pivot position of the transport carriage 22 and/or the transport unit 21 is controlled by a control device. In the present case, the control device can be operated mechanically. The control device comprises a first control element, here for example in the form of a control rail 19, which acts together with a second control element 29 connected to the transport unit 21, here indirectly via the transport carriage 22. The position of the control rail 19 relative to the support rail 12 defines the pivoting of the transport container 21 and/or the transport carriage 22.

In one embodiment, the control rail 19 is stationary. This results in each transport unit being displaced from the receiving position to the handover position and vice versa at the same point based on its position along the transport direction. This is particularly useful if the conveyor device has exactly one handover area at which all product parts F2 are handed over.

In one embodiment, the conveyor has several handover areas A3a, A3b, A3c. A section of such a conveyor is shown schematically in FIG. 6. The conveyor device can selectively handover the parts to one of the several handover areas.

In one embodiment, the control rail 19 has separately displaceable control rail segments 19a,b,c in sections for this purpose. The control rail segments 19a,b,c can each be assigned to a specific handover area. The control rail segment is thereby displaceable between a handover position and a receiving position. The displacement can take place by means of an actuator 18a-c, for example a pneumatic actuator. The actuator 18a-c can be assigned to one of the control rail segments 19a-c in each case.

In FIG. 6, control rail segments 19b, c are in the handover position and control rail segment 19a is in the receiving position. If the transport unit 21 and/or the transport carriage 22 passes a control rail segment 19a that is in the receiving position, the transport unit 21 remains in the receiving position. The product parts in the corresponding transport unit 21 are not handed over in the handover area A3a, which is assigned to this control rail segment 19a.

If the transport unit 21 and/or the transport carriage 22 passes a control rail segment 19b,c that is in the handover position, the transport unit 21 is displaced to the handover position. The product parts in the corresponding transport unit 21 are then handed over in the handover area A3b, to which this control rail segment is assigned in the handover position. In the subsequent handover area A3b, no more product parts are then handed over, since these have already been handed over in handover area A3b, even if the assigned control rail element 19c is in the handover position.

The displaceable control rail segments 19a,b,c can be followed by a return segment 19r so that the transport units 21 are all subsequently displaced to the receiving position.

The individual transport units 21 are drive-connected to each other via a traction means 26 (FIG. 4). The traction means 26 is in particular an elastic rope. This results in particular in a ropeway-like configuration in which the individual transport units are pulled one behind the other by the traction means.

The connection of the traction means 26 to the respective transport units 21 can be made in particular indirectly via the respective transport carriage 22.

At an attachment point 26F, the traction means 26 is drive-connected to the respective transport unit 21 and/or the respective transport carriage 22. The traction means can be fastened at the attachment point 26F, e.g. by clamping.

The traction means 26 may be driven by a motor, which is not shown, and a traction sheave connected thereto.

In particular, the transport units 21 are attached to the traction means 26 at evenly spaced intervals. The traction means 26 can comprise several individual sections, which are connected to one another, in particular on a transport unit 21 or the transport carriage 22, to form a traction means 26.

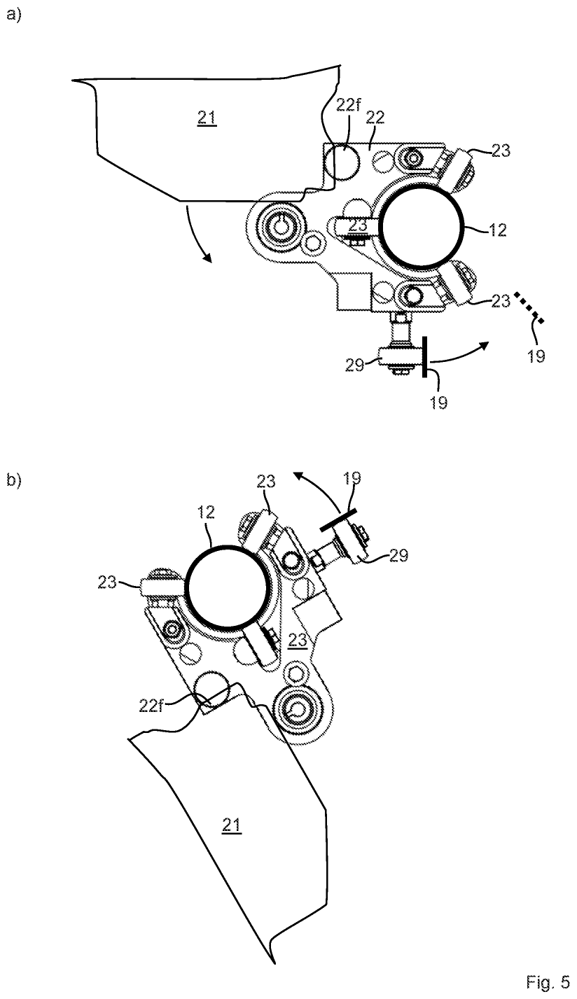

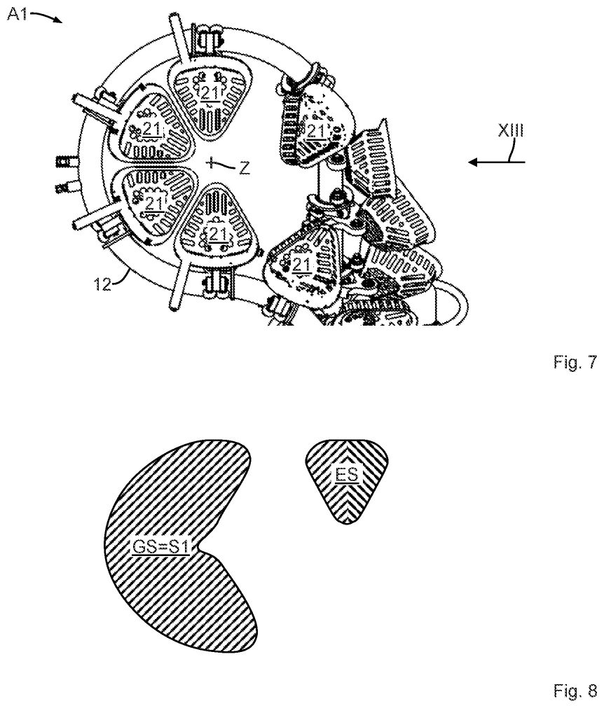

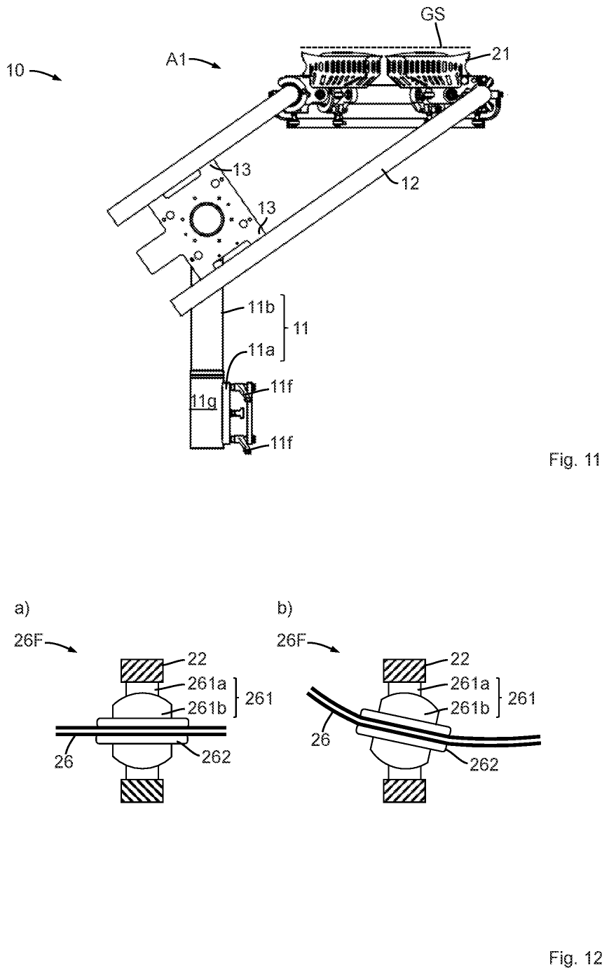

FIG. 7 shows the takeover area A1 in top view. It can be seen that a plurality, in this example four, of the transport units 21 are now positioned close to each other in such a way that they provide a common collection area for product parts. Together, these transport units 21 form a circular sector shape. Together, these transport units 21 form a total collecting surface GS, which is the dashed area shown in FIG. 8. Those product parts F2 which hit this total collecting surface GS are automatically caught by one of the transport units 21. Any gaps between the transport units are so small that the product parts intended in the intended use cannot fall through there. In FIG. 11, it can be seen that the plurality of transport units 21 are arranged next to each other in a common plane, thus forming the total collecting surface GS (shown schematically above in dashed lines).

The total collecting surface GS corresponds to at least twice, in particular three or four times, an individual collecting surface ES of a single transport unit, which is shown next to the total collecting surface GS in FIG. 8. The gaps between the individual transport units 21 are so small that no product parts F2 can fall through between the gaps. Rather, the gaps thus contribute to the total collection area such that the total collection surface GS is greater than the sum of the individual collection surfaces ES of the participating transport units 21. In this case, GS>n×ES, where n is the number of participating transport units 21. In the example according to FIG. 8, n=4.

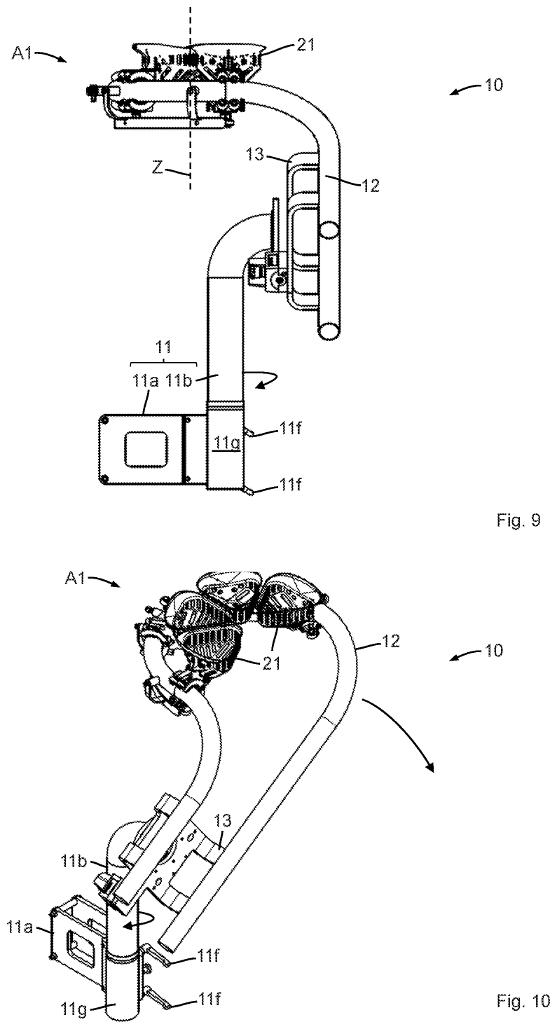

The support rail 12 is part of a holding arrangement 10 (FIGS. 9, 10). In the present example, the support arrangement 10 also includes the rail holder 13 and the base supports.

The base support 11 is designed in two parts, for example. A first base support part 11a is immovable, in particular firmly connected to the substrate or a wall. A second base support part 11b is movable if required. The support rail 12 is fastened to the second base support part 11b, in particular indirectly via the rail holder 13.

The support rail 12 can thus be displaced between an operating position and a maintenance position. In the operating position, the takeover of the product parts from the feed device 110 can take place in the takeover area. In the maintenance position, the support rail 12 is removed from the area below the delivery unit 112 of the feed device. Now the delivery unit 112 can be cleaned from below.

In the present case, the second base support part 11b is designed to be rotatable relative to the first base support part 11a, with a swivel joint 11d being provided. Fixing means 11f, for example a locking screw, can be used to hold the alignment of the two base support parts 10a, 11b relative to one another.

A wiper 25 is provided between individual or all of the transport units 21, which moves along the support rail 12 between individual transport units 21. The wiper 25 is set up to mechanically remove impurities from the support rail 12. The wiper 25 may be attached to, and move with, one of the transport carriages 22 for guiding the transport units, respectively. In this case, the wiper is arranged in particular in front of the transport carriage 22 in the conveying direction. Alternatively, a separate transport carriage is also conceivable, on which only the wiper is provided. The wiper can have a rubber lip 25L that is in sliding contact with the support rail 12.

FIG. 12 shows the rope fastening 26F in detail in cross-section. The rope fastening 26F has a rope receptacle 262, relative to which the rope 26 is connected in a tension-proof manner. The tension-proof connection can be ensured by a clamping screw.

The rope receptacle 262 is fixed relative to the transport carriage 22. The rope attachment 26F has a joint 261, which is arranged between the rope receptacle and the transport carriage. The joint 261 allows the direction of the rope receptacle 262 to be changed relative to the transport carriage 22.

In particular, the joint 261 is a ball and socket joint having a joint inner portion 261b and a joint outer portion 261a which slidably engage each other at a common ball portion surface.

Due to the curved course of the support rail 12, there is a constant change in the alignment of adjacent transport carriages 22. The articulated rope support avoids stress peaks on the rope itself, which has a positive effect on the durability of the rope.

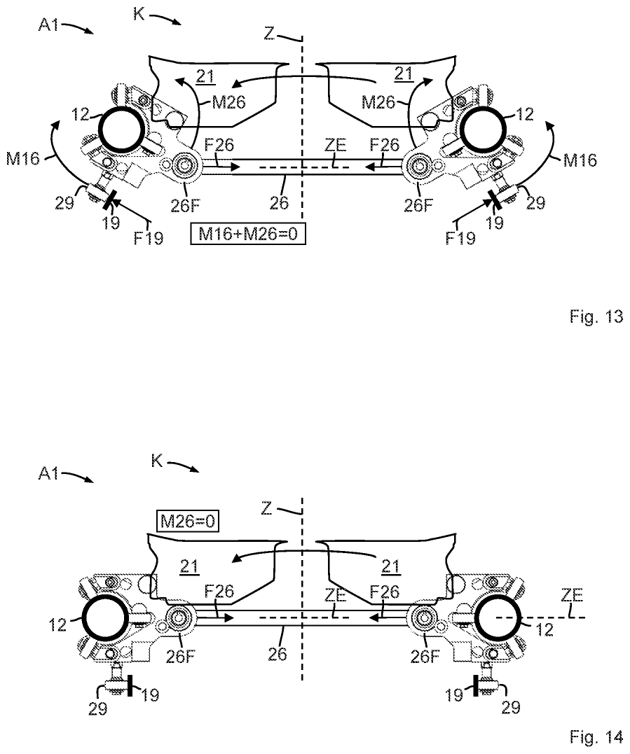

FIG. 13 shows the takeover area A1 in connection with transport units 21 arranged there. The description of the following problem definition serves as a representative for all curve areas of the conveyor device 1. In the figure, the transport units shown behind the picture plane are not shown for better comprehensibility of the figure.

As previously described, the transport units 21 are all connected to the traction means 26. In straight sections, the guidance of the traction means is comparatively unproblematic; in curved sections, the traction means can lead to tensions.

In the takeover area A1, the transport units 21 are guided along a 180° turn in a curved section K (FIG. 7). FIG. 13 shows a design of the takeover area. This means that the traction means not only transmits a traction force along the conveying direction but also a force F26 that leads in the direction of the center of the bend.

The force generates a swivel torque M26, which acts on the transport units 21 in an upward swiveling direction. However, the control elements 19, 29 ensure that the transport units 21 remain in the desired position. They now generate a counter-torque M16 counteracting the swivel torque M26. For this purpose, control forces F19 are provided by the control elements 19, 29.

The control forces F29 generate friction to the control elements, which in turn slow down the entire conveying process. In particularly unfavorable embodiments, the occurrence of the swiveling moments and the associated forces can lead to tensioning or jamming, which brings the entire conveyor device to a standstill.

FIG. 14 shows an alternative design. In the takeover area A1, the traction means 26 are arranged in a traction means plane ZE that lies in a common plane with the support rail 12. The forces pointing to a center axis Z of the bend now no longer generate a swiveling moment M26. This means that the opposing support by the control elements 19, 29 can be dispensed with. The control elements 19 are now only provided to hold the transport units 21 in the correct orientation with comparatively low force application, without having to counteract significant swivel moments for this purpose. The resistance forces occurring at the control elements 1, 29 are thus significantly lower than in the design according to FIG. 13.

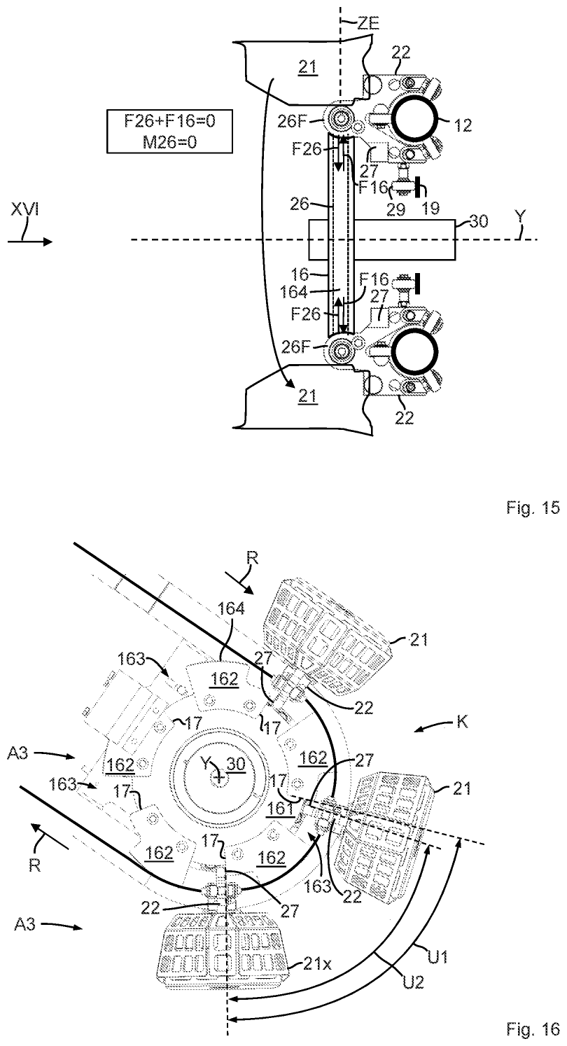

FIG. 15 shows an alternative possibility for avoiding resistance forces in the area of a curved section K of the conveyor device 1. This is implemented at the handover area A3 as an example. At the handover area A3, the transport units move around a horizontal axis Y in the curved section K (see supplementary FIG. 1). The traction means 26, which connect the transport units 10 to one another, are arranged in a traction means plane ZE that does not run through the support rail 12. In this respect, the traction means 26 generate, in principle, a rope force F26 which could act on the rope fastenings 26F toward the axis Y. A support wheel 16 is provided, which guides the traction means 26 in the area of the curve. The drive wheel 16 has a peripheral surface 164, possibly interrupted, against which the traction means 26 rests for radial support.

The forces F16 and F26 thus neutralize each other, so that the transport unit is not subjected to any swiveling moment M26 in the direction of axis Y, which would again have to be compensated by the control elements.

Alternatively or in combination, the support wheel 16 directly supports the transport unit 11 and/or the transport carriage 22 radially with a support force F16 and may be arranged parallel to the support means plane.

The support wheel 16 also represents a drive wheel and is drive-connected to a drive 30, for example a drum motor. The drive wheel 16 can be connected to the drum motor 30 by a material or force fit; in particular, the drive wheel is attached to a circumferential surface of the drum motor. A second drive surface 27 is provided, through which a driving force is transmitted non-positively from the drive wheel 16 to one of the transport units 21 and/or the transport carriages 22. The transmission of the driving force is not shown in FIG. 15. By connecting the transport units 21 and/or the transport carriages 22 to each other by the traction means 26, the drive force is also transmitted to the other transport units 21 and/or transport carriages 22.

FIG. 16 shows the drive wheel 16 in more detail. The drive wheel 16 is optionally designed in two parts here and has an inner wheel 161 and several circumferentially distributed wheel attachments 162.

The drive wheel 16 has a plurality of circumferentially distributed first drive surfaces 17, each of which cooperates with second drive surfaces 27 to transmit the driving force from the drive wheel 16 to the transport units 21 and/or the transport carriages 22. For this purpose, the drive wheel has radially outwardly engagement recesses 163 which is partially bounded by the first drive surface and is arranged in the second drive surface. The transport carriage or the transport unit must engage positively in the engagement recess 163. In the present case, the engagement recess 163 is formed in each case by an intermediate space between two circumferentially adjacent wheel attachments 162. For the sake of clarity, only some of the engagement recesses 163 in FIG. 16 are provided with reference lines.

The rope receptacle 262 is arranged radially on the outside of the drive wheel. It should be noted here that the traction means is preferably merely placed in the rope receptacle without any jamming occurring between the rope receptacle and the traction means. Even if the rope receptable is named in this manner, this does not implicitly mean that the traction means is necessarily a rope.

Optionally, the drive surfaces 27 and/or the rope receptacle 262 are provided on the wheel attachments.

FIG. 16 shows that only the transport unit 21x or its transport carriage 22 is in drive connection with the drive wheel 16, since the associated drive surfaces 17, 27 are in contact with each other. The respective second drive surface 27 of the other transport units 21 (reference signs 21 without x) are not in contact with the respective nearest first drive surface 17 on the drive wheel 16. In this case, the drive surfaces 17, 27 are kept at a distance from one another. This is achieved by the first circumferential distance U1 of two first drive surfaces 17 being greater than the second circumferential distance U2 of the successive following transport units 21 or transport carriages 22, this distance being to be understood in the angular dimension about the common axis of rotation Y.

This ensures that only that transport unit 21x is in drive connection with the drive wheel which, viewed in the conveying direction R, assumes the foremost position of all transport units 21 located at the drive wheel 16. This in turn ensures that reliable threading of the transport carriages or transport units into engagement recesses 163 of the drive wheel 16 is guaranteed, even if the traction means, which is preferably of elastic design, are subject to a certain linear expansion. Such linear expansion may occur due to wear or may be caused by unexpected high resistance in the conveyor device. In the present example, the drive connection is preferably positive-locking, since this allows a predetermined cycle to be maintained.

Strictly speaking, FIG. 16 shows a direct drive connection between the drive wheel 16 and the transport carriage 22, since the second drive surface 27 is arranged on the transport carriage. Since the transport carriage 22 is firmly connected to the associated transport unit 21, this describes a drive connection between the drive wheel and the transport unit. The structural separation between the transport carriage and the transport unit is irrelevant here. It is therefore also possible for the second drive surface to be directly connected to the transport unit or to another element which also circulates with the transport unit in the conveying direction R.

In particular, the transport carriage can be regarded as a component of the transport unit, especially with regard to the drive connection between the drive wheel and the transport unit. Other parts that rotate firmly with the transport unit can also be regarded as its components.

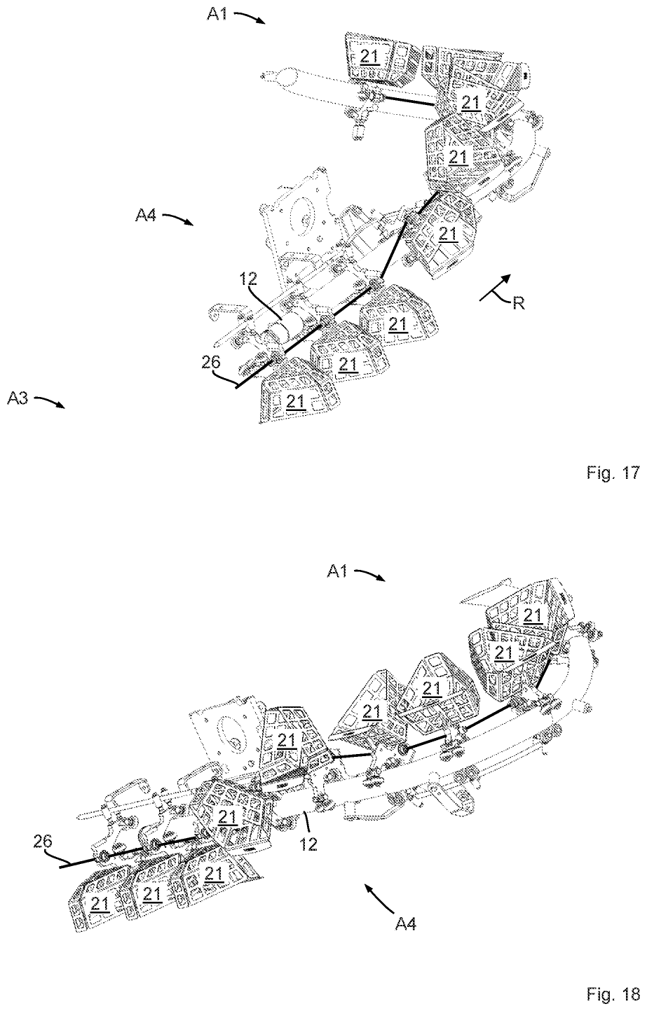

FIGS. 17 and 18 are described together. The transport units 21 leave the handover area A3 (the position of the handover area A3 is indicated in FIG. 17 only by a reference sign with an arrow pointing to nothing) in their handover position and enter the return area A4 in this position. At the takeover area A1, the transport units are in their receiving position.

In the return area A4, the transport units 21 are therefore pivoted from their handover position to the receiving position. For this purpose, the transport units 21 follow a spiral path of movement at least in sections.

In the spiral section of the conveying direction R, there is a change in the circumferential position of the transport unit 21 on the support rail 12, while at the same time there is an axial displacement of the transport unit 21 along the support rail 12.

As explained with reference to FIGS. 13 to 17, a defined alignment between curves in the conveying direction R or support rail 12 and the traction means 26 is an important prerequisite for the low-tension and thus low-friction operation of the conveyor device 1. This defined alignment can be realized in the present case by providing the spiral movement path in a straight section of the support rail 12. When entering the curve at the takeover area A1, the spiral movement is already completed and the defined alignment according to FIG. 14 is established.

### LIST OF REFERENCE SIGNS

100 conveyor arrangement
1 conveyor device
A1 takeover area
A2 transfer area/descending section
A3 handover area
A4 return area/ascending section
F1 goods unit
F2 conveyed goods/product parts
10 support arrangement
11 base support
11a first base support part
11b second base support part
11g joint
12 support rail
13 rail holder
16 support wheel/drive wheel
161 inner wheel
162 wheel attachment
163 engagement recess
164 peripheral surface
17 first drive surface on drive wheel
18 actuator
19 first control element (control rail)
19a,b,c control rail segment
19r return segment
21 transport unit (basket)
21b bottom wall
21s side wall
21j taper
21f fastening section on the transport unit
21a recesses
21o receiving opening
21k collar
22 transport carriage (C-shaped)
22f fastening section on transport carriage
23 transport roller
25 wiper
25L rubber lip
26 traction means/rope
26F traction means attachment point
261 joint
261a joint outer portion
261b joint inner portion
262 rope receptacle
27 second drive surface on transport carriage
29 second control element (control roller in engagement with 19)
30 drive/drum motor
110 feeding device
111 feeding conveyor
112 discharging unit (cutter)/dismantling device
120 discharging device
121 discharging conveyor
R conveying direction
GS total collecting surface
ES individual collecting surface
Z vertical axis
Y horizontal axis
F19 control force by control elements
F26 rope force
M16 control element-conditioned counter torque
M26 rope-conditional swivel moment
K curve section
ZE traction means plane
U1 first circumferential distance
U2 second circumferential distance

1. A conveyor device (1), adapted to take over a conveyed good (F2), optionally a piece of meat, at a takeover area (A1) from an upstream feeding device (110), to handover the conveyed good (F2) at a handover area (A3), optionally to a downstream discharging device (120), and to transfer the conveyed good (F2) in a transfer area (A2) from the takeover area (A1) to the handover area (A3), the conveyor device (1) comprising a plurality of discrete transport units (21), in particular transport baskets (21), the transport units (21) being arranged optionally in a circulating manner,
wherein the transport units (21) are adapted to take over the conveyed good (F2) at the takeover area (A1), in particular to catch a conveyed good provided by a meat dismantling device (112) in the vertically falling state, to be transferred between the takeover area (A1) and the handover area (A3), and to handover the conveyed good (F2) at the handover area (A3).

2. The conveyor device (1) according to claim 1, wherein the conveyor device (1) is a food conveyor device, in particular a meat conveyor device, in particular wherein the conveyed good (F2) is a food part, in particular a meat part, in particular a poultry part.

3. The conveyor device (1) according to claim 1,
wherein the takeover area (A1) has a takeover surface with a first surface area (S1) when viewed in top view,
wherein the handover area (A3) has a handover surface with a second surface area (S2) when viewed in top view, and
wherein the first surface area (S1) being larger than, in particular at least twice as large as, the second surface area (S2).

4. The conveyor device (1) according to claim 1,
wherein the transport units (21) are mounted in such a way that they can be displaced individually between a receiving position and a handover position,
wherein in the receiving position the conveyed good (F2) is received fail-safe in the respective transport unit (21), and
wherein in the handover position the conveyed good (F2) falls out of the respective transport unit (21) due to gravity,
optionally wherein the transport unit is pivotable between the receiving position and the handover position.

5. The conveyor device (1) according to claim 1, further comprising a control arrangement (19, 29) which is arranged to displace the transport unit (21), in particular as a function of its position, between the receiving position and the handover position,
wherein the control arrangement (19, 29) optionally displaces the transport units (21) into the handover position when the transport basket (21) reaches the handover area (A3), and/or optionally displaces the transport units (21) into the receiving position at the latest before the takeover area (A1) is reached.

6. The conveyor device (1) according claim 1, wherein the conveyor device (1) comprises a plurality of handover areas (A3a,b,c), and wherein the control arrangement (19, 29) is adapted to selectively displace the transport unit (21) between the receiving position and the handover position so that the conveyed good is selectively handed over at a selected handover area (A3b) selected from the plurality of handover areas (A3a,b,c).

7. The conveyor device (1) according to claim 6, the control arrangement (19, 29) further comprising a control rail (19) which is arranged in sections in a defined orientation with respect to the transport units (21) movable in a conveying direction (R), in particular the position, in particular the handover position or the receiving position, of the transport unit (21) in the associated section is predetermined by the orientation, defined in sections, of the control rail (19).

8. The conveyor device (1) according to claim 7, wherein the sectionally defined orientation of the control rail (19), in particular the orientation of a displaceable control rail segment (19a-c) of the control rail (19), can be adjusted by an actuator (18).

9. The conveyor device (1) according to claim 1, wherein the transport units (21), viewed in top view, each provide an individual collecting surface (ES), a number (n) of transport units (21) being arranged relative to one another in the takeover area (A1) in such a way that they form a closed total collecting surface (GS), which is larger than the individual collecting surface (ES),
optionally wherein the total collecting surface (GS) is at least twice, preferably at least three times or four times, the individual collecting surface (ES), and/or
wherein the total collecting surface (GS) is larger than the individual collecting surface (ES) multiplied by the number (n).

10. The conveyor device (1) according to claim 1, wherein the transport unit (21) has a triangular shape when viewed in top view, and/or a plurality of transport units (21) arranged next to one another form a circular sector shape, in particular when these are arranged in the takeover area (A1).

11. The conveyor device (1) according to claim 1,
wherein the transport unit (21) has a wall (21b, 21s) which comprises a plurality of recesses (21a), the proportion of the recesses (21a) making up at least 30% of the wall, and/or
wherein the transport unit (21) has a downwardly tapering collar (21k) on the upper side, an individual collecting surface (ES) formed by the transport unit being enlarged relative to a receiving space by the collar (21k).

12. The conveyor device (1) according to claim 1, further comprising a support rail (12) arranged for supporting the transport unit (21) between the takeover area (A1) and the handover area (A3), optionally wherein the support rail has a three-dimensionally curved course and/or optionally wherein the support rail has at least one ascending section (A4) and one descending section (A2).

13. The conveyor device (1) according to claim 12, wherein the support rail (12) has a circular cross-section.

14. The conveyor device (1) according to claim 1, wherein the transport unit (21) is fastened to a transport carriage (22) which can be moved along a support rail (12), further wherein the transport carriage (22) optionally has a C-shaped configuration when viewed in the conveying direction (R).

15. The conveyor device (1) according to claim 12, wherein the support rail (12) can be displaced, at least in sections, between an operating position and a maintenance position, the support rail (12) being arranged in the operating position in such a way that the transport units (21) can take over the conveyed good (F2) at the takeover area (A1), and when in the maintenance position, the support rail (12) is displaced in such a way that the support rail is removed from the takeover area (A1).

16. The conveyor device (1) according to claim 12, wherein the support rail (12) is fastened to a base support (11) with two base support parts (11a, 11b),
wherein the support rail (12) being fastened to a second base support part (11b), and a first base support part (11a) being held in particular in a fixed position, the second base support part (11b) being mounted displaceably, in particular pivotably, relative to the first base support part (11a), and in particular the second base support part (11b) being mounted by means of a fixing means (11f) relative to the first base support part (11a), the second base support part (11b) being mounted displaceably, in particular pivotably, with respect to the first base support part (11a), and it being possible in particular for the second base support part (11b) to be fixed with respect to the first base support part (11a) by means of a fixing means (11f), in particular it being possible for the conveyor device (11a) to be released from an area below a delivery unit of a feed device as a result of the displaceability of the second base carrier part (11b) with respect to the first base carrier part of a support arrangement (10).

17. The conveyor device (1) according to claim 12, further comprising a wiper (25) which is arranged to travel along the support rail (12) and which is adapted to at least partially remove contaminants on the support rail (12), optionally wherein the wiper (25) has a rubber lip (25L) which is in sliding contact with the support rail (12),
optionally wherein the wiper (25) is movable along the support rail (12) together on a transport carriage (22) and/or a transport unit (21).

18. The conveyor device (1) according to claim 1, wherein the transport units (21) and/or the transport carriages (22), in particular two transport units (21) and/or transport carriages (22) adjacent in the conveying direction, are at least indirectly drive-connected to one another via a traction means (24),
optionally wherein:
the traction means (26) being an elastic rope; and/or
the traction means (26) being drive-connected to the transport units (21) and/or the transport carriages (22) at, in particular, regular intervals.

19. The conveyor device (1) according to claim 18,
wherein the traction means (26) is connected in an articulated manner to the respective transport unit (21) and/or the respective transport carriage (22),
in particular by means of a joint (261);
in particular in such a way that an alignment of the traction means with respect to the respective transport unit (21) and/or the respective transport carriage (22) can be adjusted as a function of the relative alignment of two adjacent transport units (21) and/or transport carriages (22) with respect to one another.

20. The conveyor device (1) according to claim 18, wherein the conveying direction (R) has a curved course in a curved section (K), and within the curved section (K) the traction means (26) is arranged within a common traction means plane (ZE).

21. The conveyor device (1) according to claim 20,
wherein the common traction means plane (ZE) is aligned with a rail plane defined by a center axis of the support rail (12) in the curve section (K); and/or
optionally wherein in the common traction means plane (ZE) or parallel to the common traction means plane (ZE), a support wheel (16) is provided, which is set up for radial support of the traction means (26), the transport carriage (22) and/or the transport unit (21),
optionally wherein with the traction means (26), the transport carriage (22) and/or the transport unit (21) being guided in the curved section (K) on a peripheral surface (164) of the support wheel.

22. The conveyor device (1) according to claim 1, wherein the transport units (21) sectionally follow a spiral path of movement, the spiral path of movement being arranged only in a rectilinear section of the conveying direction (R) and/or of a support rail (12) defining the conveying direction.

23. The conveyor device (1) according to claim 1, further comprising a drive wheel (16), which is set up for positive drive force transmission to a transport unit (21) and/or a transport carriage (22) via two drive surfaces (17, 27), wherein a first drive surface (17) is arranged on the drive wheel (17) and a second drive surface (27) is arranged on the transport unit (21) and/or the transport carriage (22).

24. The conveyor device (1) according to claim 23, wherein second drive surfaces (17) of two adjacent transport carriages (21) and/or transport units (21) on the drive wheel (16) have a second circumferential distance (U2) from one another, and wherein two first drive surfaces (17) for driving the transport carriages (21) and/or transport units (21) have a first circumferential distance (U1) from one another, and further wherein the second circumferential distance (U2) is smaller than the first circumferential distance (U1).

25. A conveyor arrangement (100), comprising:
a feeding device (110) for providing conveyed good (F2) at the takeover area (A1), in particular with a meat cutting device (112) arranged at the takeover area (A1), which is set up to separate meat parts from a meat carcass (F1) and to provide them at the takeover area (A1) as conveyed good (F2) in a vertically falling state,
the conveyor device (1) according to claim 1 for transferring the conveyed good (F2) provided at the takeover section (A1) from the feeding device (110) to the handover area (A3), and
optionally, a discharging device (110) for discharging the conveyed good (F2) from the transfer section (A3).

26. The conveyor arrangement (100) according to claim 25,
wherein a dismantling device, in particular a meat dismantling device (112), is arranged at the takeover area (A1),
in particular the meat cutting device (112) is set up to separate meat parts, in particular poultry parts, from a meat carcass, in particular poultry carcass (F1), and to make them available at the takeover area (A1) as conveyed good (F2), in particular in the vertically falling state.

27. Use of a conveyor device (1) according to claim 1 for taking over conveyed goods (F2) in the form of food parts, in particular meat parts, at the takeover area (A1) and for handover the conveyed good (F2) at the handover area (A3), in particular to a discharge device.
